(19) United States
(12) Patent Application Publication
(10) Pub. No.: US 2008/0114797 A1
(43) Pub. Date: May 15, 2008

(54) Importing non-native content into a document

(75) Inventors: Brian M. Jones, Redmond, WA (US); Robert A. Little, Redmond, WA (US); Tristan A. Davis, Redmond, WA (US); Ali Taleghani, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/599,682

(22) Filed: Nov. 14, 2006

(51) Int. Cl. G06F 7/06; G06F 17/30

(52) U.S. Cl. 707/101; 707/E17.001

(57) ABSTRACT

Content that is stored using a non-native format is imported into a document using a native open file format. A document structured according to the open file format is designed such that it is made up of a collection of modular parts that are stored within a container. Non-native content is imported into an application's native file format by including the non-native content into one or more of the modular parts of the document. The non-native content is included within a part without the need to change the formatting of the non-native content. The application accesses the included non-native content and imports the non-native content to the native format of the application.

### BACKGROUND

A large amount of time is invested by businesses and individuals in creating content for documents. This content can be stored in a variety of different formats. For example, some content may be stored using the Rich Text Format (RTF); some content may be stored using the HyperText Markup Language (HTML) format, while other content may be stored using some other standard or proprietary format. Importing this content into an application that uses a different format can be complex and challenging. This difficulty in importing content has deterred many entities from even attempting to migrate to an application that utilizes a different format.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Content that is stored in non-native formats is imported into a document using an open file format. A document structured according to the open file format is designed such that it is made up of a collection of modular parts that are stored within a container. The modular parts are logically separate but are associated with one another by one or more relationships. Non-native content is imported into an application's native format by including the non-native content into one or more of the modular parts of the document. The application accesses the non-native content and imports and migrates the non-native content to the native format of the application.

These and various other features, as well as other advantages, will be apparent from a reading of the following detailed description and a review of the associated drawings.

### BRIEF DESCRIPTION OF THE DRAWINGS

FIG. 1 illustrates an exemplary computing device;

FIG. 2 shows an exemplary document container with modular parts; and

FIGS. 3-4 are illustrative routines performed in performed in importing non-native content into a document in a modular content framework.

### DETAILED DESCRIPTION

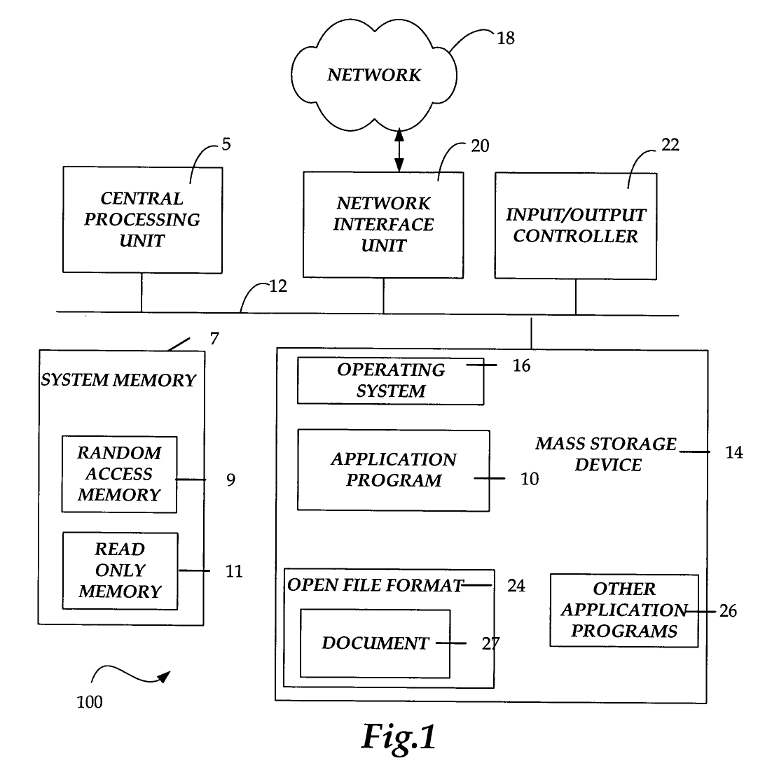

Referring now to the drawings, in which like numerals represent like elements, various aspects will be described herein. In particular, FIG. 1 and the corresponding discussion are intended to provide a brief, general description of a suitable computing environment in which embodiments of the invention may be implemented. While the invention will be described in the general context of program modules that execute in conjunction with program modules that run on an operating system on a personal computer, other types of computer systems and program modules may be used.

Generally, program modules include routines, programs, operations, components, data structures, and other types of structures that perform particular tasks or implement particular abstract data types. Moreover, other computer system configurations, including hand-held devices, multiprocessor systems, microprocessor-based or programmable consumer electronics, minicomputers, mainframe computers, and the like may be used. A distributed computing environment where tasks are performed by remote processing devices that are linked through a communications network may also be utilized. In a distributed computing environment, program modules may be located in both local and remote memory storage devices.

Referring now to FIG. 1, an illustrative computer architecture for a computer 100 will be described. The computer architecture shown in FIG. 1 illustrates a computing apparatus, such as a server, desktop, laptop, or handheld computing apparatus, including a central processing unit 5 (“CPU”), a system memory 7, including a random access memory 9 (“RAM”) and a read-only memory (“ROM”) 11, and a system bus 12 that couples the memory to the CPU 5. A basic input/output system containing the basic routines that help to transfer information between elements within the computer, such as during startup, is stored in the ROM 11. The computer 100 further includes a mass storage device 14 for storing an operating system 16, application programs, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVJS’), or other optical storage, magnetic cassettes, magnetic tape, magnetic disk storage or other magnetic storage devices, or any other medium which can be used to store the desired information and which can be accessed by the computer 100.

The computer 100 may operate in a networked environment using logical connections to remote computers through a network 18, such as the Internet. The computer 100 may connect to the network 18 through a network interface unit 20 connected to the bus 12. The network interface unit 20 may also be utilized to connect to other types of networks and remote computer systems. The computer 100 may also include an input/output controller 22 for receiving and processing input from a number of other devices, including a keyboard, mouse, or electronic stylus (not shown). Similarly, an input/output controller 22 may provide output to a display screen, a printer, or other type of output device.

As mentioned briefly above, a number of program modules and data files may be stored in the mass storage device 14 and RAM 9 of the computer 100, including an operating system 16 suitable for controlling the operation of a networked personal computer, such as the WINDOWS XP operating system from MICROSOFT CORPORATION of Redmond, Wash. The mass storage device 14 and RAM 9 may also store one or more program modules. In particular, the mass storage device 14 and the RAM 9 may store an application program 10. For example, the application program may be a word processing application program 10 that is operative to provide functionality for the creation and structure of a word processing document, such as a document 27, in an open file format 24. According to one embodiment, the application program 10 and other application programs 26 comprise the OFFICE suite of application programs from MICROSOFT CORPORATION including the WORD, EXCEL, and POWERPOINT application programs.

The open file format 24 simplifies and clarifies the organization of document features and data. The application program 10 organizes the parts of a document (native formatted content, non-native formatted content, document properties, application properties, custom properties, and the like) into logical, separate pieces, and then expresses relationships among the separate parts. These relationships, and the logical separation of the parts of a document, make up a file organization that can be easily accessed without having to understand a proprietary format. As used herein, the terms “non-native content” and “non-native formatted content” includes content that is formatted using a different formatting standard as compared to the native open file format used by application program 10. This could include, but is not limited to: HTML content, RTF content, binary content, and the like.

According to one embodiment, the open file format 24 utilizes the extensible markup language (“XML”). XML is a standard format for communicating data. In the XML data format, a schema is used to provide XML data with a set of grammatical and data type rules governing the types and structure of data that may be communicated. The modular parts are also included within a container. According to one embodiment, the modular parts are stored in a container according to the ZIP format.

Documents that follow the open file format 24 are programmatically accessible both while the program 10 is running and not running. This enables a significant number of uses that were simply too hard to accomplish using the previous file formats. For instance, a server-side program is able to create a document based on input from a user, back-end server data, or some other source. A program may be created to automatically include content within a document following the open file format.

Another use is the ability to construct new documents on the server from existing pieces of business documents, enabling server side generation of new documents based on user input. For example, a group of clauses might be stored on a server as individual files in a non-native format, and a document using the native open file format may be constructed from some (or all) of these clauses based on input as to the required information for this specific contract. Generally, non-native content is referenced within the native document and the non-native content itself is stored in modular part(s) within the open file format. When the document is initially opened and it is determined that non-native content is stored in any of the modular parts, then this non-native content is migrated to the native content file format for the application and saved. The non-native content is included within modular part(s) in its non-native format. In other words, no modification is required to include the non-native content within a modular part of the document following the open file format even though the document itself is in the native format. When the application accesses the non-native content it is migrated to the main XML document at the specified location within the document, and is written out using the standard open file XML syntax when the file is saved. This assists in importing the non-native content to the native format over time, without requiring that the existing non-native content be migrated into the native format immediately.

With the industry standard XML at the core of the open file format, exchanging data between applications created by different businesses is greatly simplified. Without requiring access to the application that created the document, solutions can alter information inside a document or create a document entirely from scratch by using standard tools and technologies capable of manipulating XML. The open file format has been designed to be more robust than the binary formats, and, therefore, reduces the risk of lost information due to damaged or corrupted files. Even documents created or altered outside of the creating application are less likely to corrupt, as programs that open the files may be configured to verify the parts of the document.

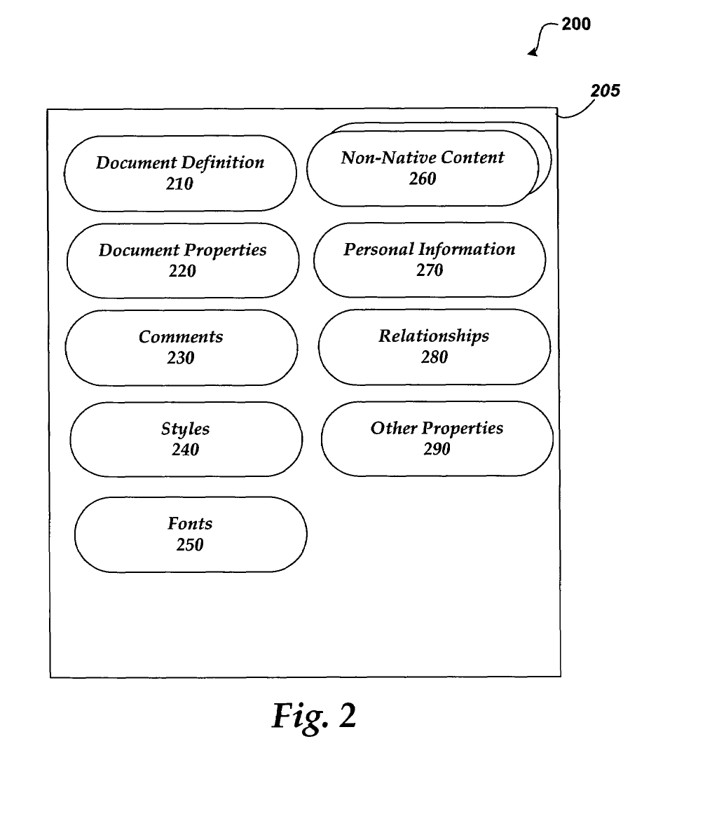

FIG. 2 shows an exemplary document container with modular parts. As illustrated, document 200 includes document container 205 that encapsulates document definition 210, document properties 220, comments 230, styles 240, fonts 250, non-native content 260, personal information 270, relationships 280 and other properties 290. The parts (210-290) enclosed by container 205 are illustrative only. Fewer or more parts may be included within a container. For example, there could be an images part to include images, a function part to include functions, a macro part including macros and the like.

According to one embodiment, the container 205 is a ZIP container. The combination of XML with ZIP compression allows for a very robust and modular format. Each document may be composed of a collection of any number of parts that defines the document. Many of the modular parts making up the document are XML files that describe application data, metadata, and even customer data stored inside the container 205. Other non-XML parts may also be included within the container, and include such parts as non-native content 260.

Non-native content part 260 stores content in any non-native format without first having to translate that existing content into the open file format represented in XML. This means that existing enterprise content in other formats (e.g. HTML or Word 97-2003's binary file format) can be included as-is within non-native content part(s) 260 when constructing natively formatted documents. According to one embodiment, any format understood by the application (e.g. plain text, HTML, RTF, MHTML, Word 97-2003 binary) may be included as a separate file in a non-native content package 260. According to one embodiment, each file including non-native content is stored in a separate non-native content part 260 that is within container 205. Alternatively, a link may be included in place of the non-native content 260 to reference the location of the non-native content. For example, the link may specify the location on a server where the non-native content is stored. The application reads the non-native content and merges that content into the XML document upon opening the file. The application then writes the content out in the XML open file format (the native format). This means that all existing business data can be immediately merged into processes and services which take advantage of the native file format without needing to upgrade all existing content into that new format, which would be a difficult and potentially error-prone process.

To incorporate the non-native content within the document, an “anchor” tag is placed within the XML document definition 210 part specifying the position at which the non-native content should be imported into the main XML document. Alternatively, the anchor tag may be placed within any part that includes document content such as document definition, comments, header, footer, and the like. The anchor tag is used to anchor the non-native content file within the native Open XML format document. According to one embodiment, a content type (e.g. application/xml for an XML file or application/txt for a text file) is specified for each file included as a non-native content part 260 that defines the format of its contents.

According to one embodiment, in order to specify the location for the import of the non-native content, a single XML tag is written into the XML document definition 210 at the appropriate location (where the content should be imported into the main host document). The anchor tag specifies a unique logical relationship targeting the actual alternative content file in the ZIP package which is to be imported at this location. This tells the application to import the specified file at this location in the document, disambiguating it from other files which may also be in the ZIP container 205 for import.

The anchor tag also includes a flag that tells the application whether to use the styles defined in the non-native content (if there are any present which are understood to the application) or to overwrite them with the styles 240 from the host document. An example will be used for clarification purposes and is not intended to be limiting. Suppose that a non-native content part 260 includes an HTML file named a.htm which defines and uses a text style “Heading 1” as Arial 24pt colored red. Now, when this non-native format content is placed within a native host Open XML formatted document, the desired result may be one of two things. The first option is keeping the non-native contents exactly as they appear according to the styles specified in the non-native HTML file. This option would maintain the existing look and formatting even when the non-native content is included in the host document. The second option is to use the styles 240 defined within document 200. This second option helps to ensure that the non-native content's formatting is consistent with the native document's styles regardless of the original formatting of the non-native format content.

When the document is saved following the import, the content is written out in the new XML file format as though it was never of a different format. According to one embodiment, when the file is saved in the native format, the non-native content parts are removed from the file as they are no longer needed.

When users save or create a document, container 205 is stored as a single file on the computer disk. The container 205 may then easily be opened by any application that can process XML. By wrapping the individual parts of a file in a container 205, each document remains a single file instance. Once a container 205 has been opened, developers can manipulate any of the modular parts (210-291) that are found within the container 205 that define the document.

The open file format enables users or applications to see and identify the various parts of a file and to choose whether to load specific components. Likewise, personally identifiable or business-sensitive information (270) (for example, comments, deletions, user names, file paths, and other document metadata) can be clearly identified and separated from the document data. As a result, organizations can more effectively enforce policies or best practices related to security, privacy, and document management, and they can exchange documents more confidently.

Whereas the parts are the individual elements that make up a document, the relationships are the method used to specify how the collection of parts come together to form the actual document. The relationships are defined by using XML, which specifies the connection between a source part and a target resource. For example, the connection between a sheet and a string that appears in that sheet is identified by a relationship. The relationships are stored within XML parts or relationship parts 280 in the document container 205. If a source part has multiple relationships, all subsequent relationships are listed in same XML relationship part. Each part within the container is referenced by at least one relationship. The implementation of relationships makes it possible for the parts never to directly reference other parts, and connections between the parts are directly discoverable without having to look within the content. Within the parts, the references to relationships are represented using a Relationship ID, which allows all connections between parts to stay independent of content-specific schema.

The following is one example of a relationship part 280 in a spreadsheet example that includes a workbook containing two worksheets:

```
<Relationships xmlns=“ .../relationships”>
<Relationship ID=“rId3”
  Type=“ .../relationships/xlStyles”
      Target=“styles.xml”/>
<Relationship ID=“rId2”
Type=“ .../relationships/xlWorksheet”
        Target=“worksheets/Sheet2.xml”/>
    <Relationship ID=“rId1”
Type=“ .../relationships/xlWorksheet”
        Target=“worksheets/Sheet1.xml”/>
    <Relationship ID=“rId5”
    Type=“ ..../relationships/xlMetadata”
        Target=“metadata.xml”/>
    <Relationship ID=“rId4”
Type=“ ..../relationships/xlSharedStrings”
        Target=“strings.xml”/>
</Relationships>
```

The relationships may represent not only internal document references but also external resources. For example, if a document contains linked pictures or objects, these are represented using relationships as well. This makes links in a document to external sources easy to locate, inspect and alter. It also offers developers the opportunity to repair broken external links, validate unfamiliar sources or remove potentially harmful links.

The use of relationships in the open file format benefits developers in a number of ways. Relationships simplify the process of locating content within a document. The documents parts don't need to be parsed to locate content whether it is internal or external document resources. The relationships may also be used to examine the type of content in a document. Additionally, relationships allow developers to manipulate documents without having to learn application specific syntax or content markup. For example, without any knowledge of how to program a spreadsheet application, a developer solution could easily remove a sheet by editing the document's relationships.

As discussed above, most parts of a document within a container can be manipulated using any standard XML processing techniques, or for the modular parts of the document that exist as native formats, such as alternatively formatted content, they may be processed using any appropriate tool for that object type. Once inside an open document, the structure makes it easy to navigate a document's parts and its relationships, whether it is to locate information, change content, or remove elements from a document. Having the use of XML, along with the published reference schemas, means a user can easily create new documents, add data to existing documents, or search for specific content in a body of documents.

The use of XML and XML schema means common XML technologies, such as XPath and XSLT, can be used to edit data within document parts in virtually endless ways.

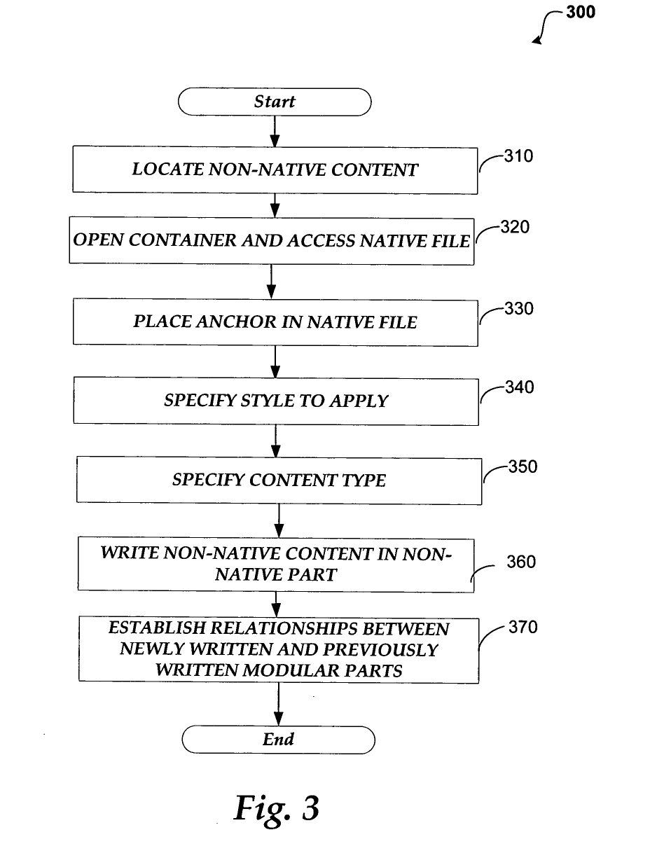

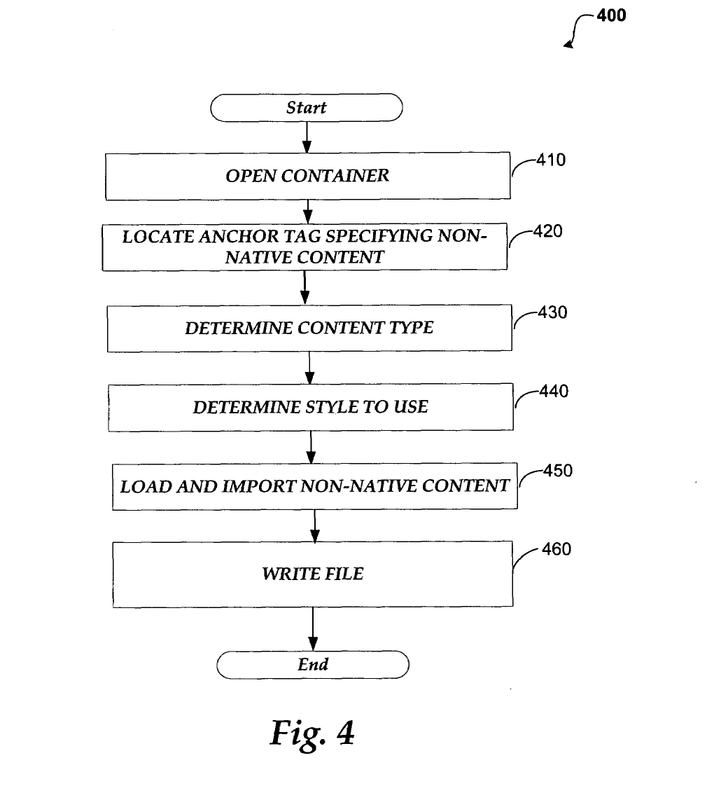

FIGS. 3-4 are illustrative routines performed in importing non-native content into a document in a modular content framework. When reading the discussion of the routines presented herein, it should be appreciated that the logical operations of various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system. Accordingly, the logical operations illustrated making up the embodiments described herein are referred to variously as operations, structural devices, acts or modules. These operations, structural devices, acts and modules may be implemented in software, in firmware, in special purpose digital logic, and any combination thereof.

Referring now to FIG. 3, after a start operation the routine 300 begins at operation 310, where non-native content to be imported into a document is located. The non-native content may be stored in many different locations, such as on a client, server, or some other storage device. According to one embodiment, the non-native content to be imported into a document includes any non-native content that is supported by the application. For example, the non-native content could include, but is not limited to: plain text, RTF, HTML, MHTML, XML, previous versions of an application's file format (e.g. Word 97-2003 binary, Word 2003 XML) and the like.

Moving to operation 320, an application program, such as a word processing application, opens a container and accesses the native file for the document in which to import the non-native content. According to one embodiment, this includes opening a ZIP file that includes the parts of the file. The native file is the part of the document that specifies the location of the content within the document.

Flowing to operation 330, the anchor specifying the location of the non-native content is placed within the native file. According to one embodiment, the anchor tag is a single XML tag that is written into the XML document definition at the appropriate location (where the content should be imported into the main host document). The anchor tag specifies the logical relationship ID for the actual alternative content file in the ZIP package which is to be imported at this location. The anchor tag tells the application to import the specified file at this location in the document, disambiguating it from other files which may also be in the ZIP container for import.

Transitioning to operation 340, the style to apply to the non-native content is specified. According to one embodiment, this includes specifying whether to use the styles associated with the native document or using the styles associated with the non-native content. Alternatively other styles may be specified that should be used for non-native content. According to one embodiment, the style to use is specified by setting a flag within the anchor tag. The anchor tag flag tells the application whether to use the styles defined in the non-native format content (if there are any present which are understood to the application) or to overwrite them with the styles from the native host document.

Moving to operation 350, the content type for the non-native content is specified within the anchor tag. The content type specifies the type of file format used by the non-native content. For example, this could by plain text, RTF, HTML, XML, and the like.

Flowing to operation 360, the non-native content is stored in a non-native part within the container. Alternatively, a link or some reference may be placed within the non-native modular part that specifies the location of the non-native content.

Continuing to operation 370, the relationship for the non-native part is specified. The relationship specifies how the non-native part fits within the collection of parts that form the actual document. According to one embodiment, the relationships are defined by using XML, which specifies the connection between a part and a resource. The process then flows to an end block and returns to processing other actions.

FIG. 4 illustrates a routine for importing non-native content into a document. After a start operation, the routine 400 moves to operation 410 where an application opens a container storing the document content.

Flowing to operation 420, an anchor tag specifying non-native content is located. The anchor tag specifies the location of the content as well as the content type and the style to use when importing the content.

Moving to operation 430, the content type for the non-native content is determined. This helps the application in determining how to load the non-native content.

Transitioning to operation 440, the style to use when importing the non-native content is determined. As discussed above, this may include determining whether to use the styles associated with the non-native content, using the styles associated with the native content or using some other style.

Next, at operation 450 the non-native content is loaded and imported according to the determinations made above. Once the content is loaded it may optionally be saved in the native format at operation 460. The process them moves to an end operation and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-readable medium having stored thereon an open file format for representing a document, the open file format representing the document in a modular content framework implemented within a computing apparatus, comprising:
modular parts that are logically separate from one another but are associated by one or more relationships; wherein the modular parts include:
a non-native content part that includes non-native content; wherein the non-native content is formatted using a different formatting method as compared to the open file format; and
a document definition part that specifies the location of content within the document; wherein the document definition part includes a reference indicating where to locate the non-native content; and
a container that encapsulates the modular parts within a single file.

2. The computer-readable medium of claim 1, wherein the reference is an anchor tag that specifies a content type for the non-native content.

3. The computer-readable medium of claim 2, wherein the anchor tag further specifies which set of styles to use when the non-native content is imported into the document.

4. The computer-readable medium of claim 3, wherein the styles used may be styles defined with the non-native content or styles defined for the document.

5. The computer-readable medium of claim 4, wherein the modular parts further include a relationships part that specifies the relationship of the modular parts within the document.

6. A computer-implemented method for importing non-native content into a document using a native format, comprising:
opening a container that encapsulates parts; wherein the parts are logically separate from one another but are associated by one or more relationships and wherein the parts include a non-native content part that is used to store non-native content; wherein the non-native content is stored using a format that is different from the native format;
locating the non-native content; and
importing the non-native content from the non-native content part.

7. The computer-implemented method of claim 6, further comprising writing the document in the native file format; wherein the non-native content part is removed after writing the document.

8. The computer-implemented method of claim 6, wherein locating the non-native content, comprises locating an anchor tag that specifies the intended location of the non-native content.

9. The computer-implemented method of claim 8, further comprising determining a content type of the non-native content.

10. The computer-implemented method of claim 8, further comprising determining the styles to use when importing the non-native content.

11. The computer-implemented method of claim 10, wherein determining the styles to use when importing the non-native content comprises determining to use styles defined with the non-native content or determining to use styles defined with the document.

12. The computer-implemented method of claim 11, further comprising determining whether the content type is supported.

13. The computer-implemented method of claim 12, wherein the anchor tag is an XML tag.

14. The computer-implemented method of claim 12, wherein the anchor tag specifies a link to the non-native content.

15. A computer-readable medium having instructions stored thereon for causing a computer to create a document that imports non-native content; comprising:
opening a container that encapsulates parts; wherein the parts are logically separate from one another but are associated by one or more relationships and wherein the parts include a non-native content part that is used to store non-native content and a document part;
specifying the location of the non-native content in the document part;
including the non-native content in the non-native content part; and
establishing the relationships between the parts.

16. The computer-readable medium of claim 15, further comprising specifying the styles to use when the non-native content is imported; wherein the styles are either those associated with the non-native content or styles associated with the document.

17. The computer-readable medium of claim 15, wherein specifying the location of the non-native content in the document part comprises placing an XML anchor tag that specifies the intended location of the non-native content.

18. The computer-readable medium of claim 17, wherein the anchor tag specifies the styles to use when the non-native content is imported and a content type of the non-native content.

19. The computer-readable medium of claim 17, wherein the anchor tag specifies a link to the non-native content.

20. The computer-readable medium of claim 15, further comprising specifying a content type of the non-native content that identifies the formatting of the non-native content.
